(19) United States
(12) Patent Application Publication
(10) Pub. No.: US 2007/0141431 A1
(43) Pub. Date: Jun. 21, 2007

(54) Fuel cell closed structure

(75) Inventors: Shengxian Wang, Shanghai (CN); Qijia Fu, Shanghai (CN); Chang Wei, Niskayuna, NY (US); Jun Cai, Shanghai City (CN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/314,619

(22) Filed: Dec. 21, 2005

(51) Int. Cl. H01M 8/02; H01M 8/08; H01M 4/94; H01M 8/06

(52) U.S. Cl. 429/34; 429/46; 429/44; 429/19; 429/217

(57) ABSTRACT

A galvanic cell with a closed structure is provided. The cell may include a galvanic cell unit having a metal hydride anode, separators positioned on opposite sides of the metal hydride anode, oxygen electrodes positioned adjacent to the separators on sides opposite to the metal hydride anode, insulator plates positioned in contact with the oxygen electrodes, an electrolyte in contact with any one or more of the metal hydride anode, oxygen electrodes, insulator plates, or separators, and a pressure vessel enclosing the galvanic cell unit.

### FIELD OF TECHNOLOGY

Embodiments of the invention relate to a closed structure for use in a fuel cell or battery. Specifically, embodiments relate to closed structure for use in a rechargeable fuel cell or metal/air battery.

### BACKGROUND

A fuel cell is an energy conversion device that converts the chemical energy of a fuel directly into electricity without any intermediate thermal or mechanical processes. Energy is released whenever a fuel reacts chemically with the oxygen in the air. A fuel cell converts hydrogen and oxygen into water. In a fuel cell, the reaction occurs electrochemically and the energy is released as a combination of electrical energy and heat. The electrical energy may be used to do useful work directly while the heat is either wasted or used for other purposes.

Because fuel cells are efficient, modular and may be adapted for use with various fuels, they may enable a transition to a secure, renewable energy future, based on the use of hydrogen. Fuel cells, in combination with solar or wind power, or any renewable source of electricity may provide a zero-emission energy system that requires no fossil fuel and may not be limited by variations in sunlight or wind flow. Fuel cells may be used by individuals and businesses and reduce their reliance on central station power generation, and long-distance, high voltage power grids. Fuel cells offer high quality power useful for computers, medical equipment and machines.

A rechargeable fuel cell is a kind of fuel cell using a metal hydride as an anode and an air electrode as a cathode, wherein the metal hydride functions as both a hydrogen source for fuel and as a hydrogen oxidization catalyst. Water is employed as an energy transformation media. When electricity is charged in a rechargeable fuel cell, water is electrolyzed into hydrogen and oxygen, in which the produced hydrogen is stored in the metal hydride. In reverse, when the electricity is exported to the loads, the hydrogen from the metal hydride anode and oxygen from air constitute a fuel cell to deliver electricity. The energy stored in the rechargeable fuel cell depends on the capacity of the metal hydride anode.

A rechargeable fuel cell may have a cathode in contact with air and the anode side sealed within the cell, thus the cell is “semi-open”. Due to the semi-open feature of the rechargeable fuel cell a mass exchange may take place during operation, such as with oxygen, nitrogen, water vapor and carbon dioxide. The management of carbon dioxide and water may be problematic in such conventional rechargeable fuel cells.

Air may contain carbon dioxide. Because potassium hydroxide solution is a relatively strong base the solution may react with carbon dioxide in air that contacts the solution to form an insoluble carbonate deposit unless prevented from doing so. The presence of such deposits may reduce the pH of the solution, may block access to the anodic surface, and may negatively impact the conductivity of the potassium hydroxide solution. If the anode is porous, carbonate deposits may block ion and/or fluid flow through the anode pores. If the base solution is in contact a porous cathode, a carbonate deposit may form within the pores in the cathode to block air passage through the cathode. This effect may be referred to as CO₂ poisoning.

Water balance may be problem for a rechargeable fuel cell. In order to keep the high conductivity of the electrolyte, the concentration of the alkali substance, such as potassium hydroxide, is usually very high. The concentration may be 25 to 30 weight percent, which leads to a low equilibrium relative humidity, such as 60 to 65 percent. However, the humidity of the ambient environment varies constantly. If the ambient humidity is higher than the equilibrium humidity of the electrolyte in the rechargeable fuel cell, the fuel cell gains water from ambient environment. In reverse, the rechargeable fuel cell loses water from the electrolyte to the ambient environment. In both cases, the balance of water in the electrolyte of the rechargeable fuel cell is broken, and may give rise to either electrolyte flooding or drying out of the rechargeable fuel cell. The conductivity of the electrolyte is also changed with any concentration variation.

Metal/air batteries may be compact and relatively inexpensive. Metal/air cells include a cathode that uses oxygen as an oxidant and a solid fuel anode. The metal/air cells differ from fuel cells in that the anode may be consumed during operation. Metal/air batteries may be anode-limited cells having a high energy density. Metal/air batteries have been used in hearing aids and in marine applications, for example.

High-pressure hydrogen nickel batteries may be employed in aerospace applications such as geosynchronous earth-orbit (GEO) commercial communications satellites and low earth-orbit (LEO) satellites. In such batteries, the high-pressure vessel may be full of hydrogen. Because the hydrogen atom is small and active, it may permeate into the crystal lattice of the vessel material, such as stainless steel. Such permeation may lead to susceptibility of embrittlement and fracture.

It may be desirable to have a fuel cell and/or a metal/air battery having differing component, characteristics or properties than those currently available.

### BRIEF DESCRIPTION

Embodiments of the invention relate to a galvanic cell structure, such as a rechargeable fuel cell structure or metal/air battery structure. According to some embodiments of the invention, the galvanic cell structure may include a galvanic cell unit comprising a metal hydride anode, separators positioned on opposite sides of the metal hydride anode, oxygen electrodes positioned adjacent to the separators on sides opposite to the metal hydride anode, insulator plates positioned in contact with the oxygen electrodes, an electrolyte in contact with any one or more of the metal hydride anode, oxygen electrodes, insulator plates, or separators, and a pressure vessel enclosing the galvanic cell unit. Each unit may include two cathodes and one anode.

In another embodiment of the invention, the galvanic cell may include a galvanic cell unit comprising a metal hydride anode, an oxygen electrode, a separator positioned between the metal hydride anode and oxygen electrode, bipolar plates positioned in contact with the oxygen electrode and metal hydride anode, an electrolyte in contact with any one or more of the metal hydride anode, oxygen electrode, bipolar plates, or separator, a barrier layer surrounding the surface area of the metal hydride anode not in contact with a bipolar plate and oxygen in the vessel, and a pressure vessel enclosing the galvanic cell unit. Each unit may include one cathode and one anode.

### DESCRIPTION OF THE DRAWINGS

Embodiments of the invention may be understood by referring to the following description, and accompanying drawings, which illustrate such embodiments. In the drawings:

FIG. 1 illustrates a perspective view depicting a rechargeable fuel cell or metal/air battery with closed structure, according to some embodiments of the invention.

FIG. 2 illustrates a perspective view depicting a cathode facing stacking model for rechargeable fuel cells or metal/air batteries, according to some embodiments of the invention.

FIG. 3 illustrates a perspective view depicting a circulation stacking model for rechargeable fuel cells or metal/air batteries, according to some embodiments of the invention.

### DETAILED DESCRIPTION

Embodiments of the invention relate to a closed structure for use in a fuel cell or battery. Specifically, embodiments relate to closed structure for use in a rechargeable fuel cell or metal/air battery.

References in the specification to “one embodiment,” “an embodiment,” “an example embodiment,” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein, the term membrane refers to a selective barrier that permits passage of protons generated at the anode through the membrane to the cathode for reduction of oxygen at the cathode to form water and heat. The terms cathode and cathodic electrode refer to a metal electrode that may include a catalyst. At the cathode, or cathodic electrode, oxygen from air is reduced by free electrons from the usable electric current, generated at the anode, that combine with protons, also generated by the anode, to form water and heat. The cathode in the fuel cell embodiments described herein may be metal or graphite, or another carbon-based material.

Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value.

In one embodiment, a rechargeable fuel cell or metal/air battery has a base solution as an electrolyte. A suitable base solution may include potassium hydroxide. Suitable anode materials be stabilized in such a base solution. A suitable base solution-stable anode material may be a metal hydride.

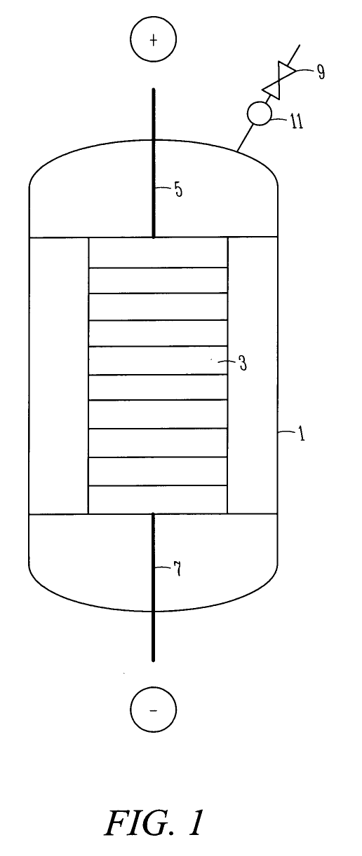

One embodiment of the invention, illustrated in FIG. 1, may include a rechargeable fuel cell or metal/air battery with a closed structure. A pressure vessel unit 1 encloses a galvanic cell unit 3. The galvanic cell unit 3 may include one or more individual galvanic cells, such as rechargeable fuel cells or metal/air batteries, in contact with one another. Positive 5 and negative feedthroughs 7 allow for electrical connection to the galvanic cell unit 3. The pressure vessel 1 may include a relief valve 9 and a pressure gauge 11 for monitoring and controlling the pressure within the vessel. The vessel 1 may be a high-pressure container. The vessel 1 may be formed from a stainless steel material or from a fiber reinforced plastic.

Restricting or blocking access to the interior of the rechargeable fuel cell, or metal/air battery may shield components of the galvanic cell from the outside environment. That is, no carbon dioxide, water, or the like is exchanged in or out of the closed system. Without contact to air, and the carbon dioxide that it contains, the effects of carbon dioxide poisoning and water evaporation may be significantly reduced or eliminated.

Susceptibility of hydrogen embrittlement for the vessel material may be reduced or eliminated. In one embodiment, the gas enclosed in the vessel is oxygen rather than hydrogen. Oxygen use may reduce or eliminate metal vessel embrittlement.

The operation for the rechargeable fuel cell in a closed system may be depicted as follows:

In normal operation:
Charging reaction
   Metal hydride electrode: 4M+4H₂O+4e→4MH+4OH⁻
   Oxygen electrode: 4OH⁻→O₂+2H₂O+4e
Discharging reaction
   Metal hydride electrode: 4MH+4OH⁻→4M+4H₂O+4e
   Oxygen electrode: O₂+2H₂O+4e→4OH⁻

Overall reaction: 4M+2H₂O→4MH+O₂

The over-charging reaction may be as follows:
Metal hydride electrode: 4H₂O+4e→2H₂+4OH⁻
Oxygen electrode: 4OH⁻→O₂+2H₂O+4e
Overall reaction: 2H₂O→2H₂+O₂

The over-discharging reaction may be as follows:

When metal Hydride excess
Metal hydride electrode: 4MH+4OH⁻43 4M+4H₂O+4e
Oxygen electrode: 4H₂O+4e→2H₂+4OH⁻
Overall: 4MH→4M+2H₂

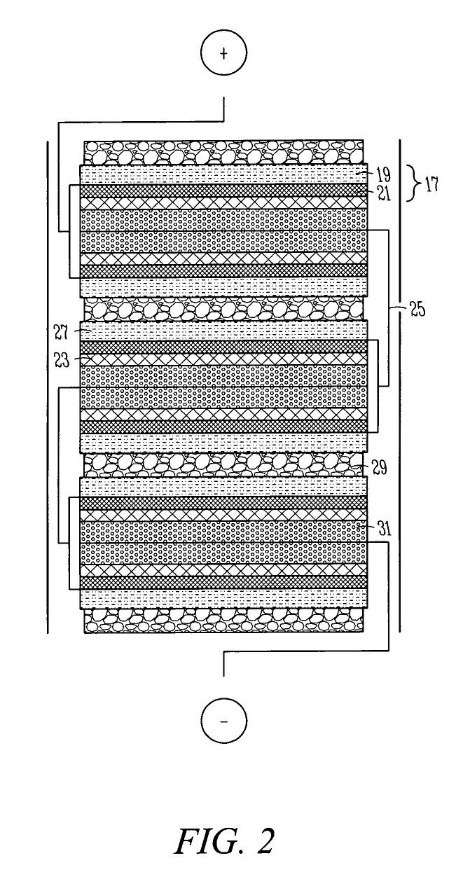

When oxygen excess
Metal hydride electrode: 4OH⁻→O₂+2H₂O+4e
Oxygen electrode: O₂+2H₂O+4e→4OH⁻
overall reaction: no net reaction Within the pressure vessel 1, the galvanic cell unit 3 may utilize a cathode facing stacking model, as illustrated in FIG. 2. A metal hydride anode 31 is positioned between separators 23. Oxygen electrodes 17, acting as cathodes, may include a diffusion layer 19 and catalyst layer 21 and are positioned on either side of the separators 23 and metal hydride anode 31. The galvanic cell unit 3 may repeat one or more times with the oxygen electrodes 17 facing each other with separators 23 and an anode 31 therebetween. Insulator plates 29, such as perforated polyethylene plates, surround each repeating galvanic cell unit 3. Lead connections 25 provide electrical contact between the individual cell units.

Electrolyte may contact with one or more of the metal hydride anode 31, the oxygen electrode 17, or the separators 23. Suitable electrolyte may include an alkaline hydroxide, such as potassium hydroxide or sodium hydroxide.

An oxygen channel 27 is defined by the space between the galvanic cell units 3 and an inner surface of the wall of the pressure vessel enclosing the units. By utilizing a cathode facing stacking model of galvanic cell units 3, the rechargeable fuel cell or metal/air battery may easily share an oxygen channel 27 for each pair of single cells. There is greater charging and discharging power due to the double cathode area. The anode 31 is insulated from oxygen. Such insulation may allow for increased ease of stacking.

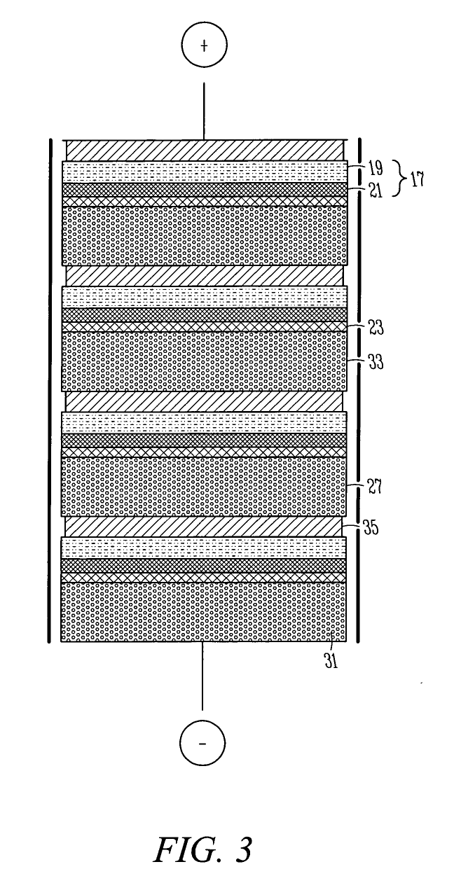

Referring to FIG. 3, a perspective view depicts a circulation-stacking model for rechargeable fuel cells or metal/air batteries. Within the pressure vessel 1, the galvanic cell unit 3 in this model may include one or more repeating units of the oxygen electrode 17, the separator 23, a metal hydride anode 31 and a bipolar plate 35 surrounding each individual cell unit. A suitable bipolar plate 35 may be conductive with grooves on both sides. Suitable conductive material may include stainless steel, graphite, or conductive plastic.

An oxygen channel 27 may be defined by the space between the galvanic cell units 3 and an inner surface of the wall of the pressure vessel enclosing the units. Electrolyte may contact with any one or more of the metal hydride anode 31, oxygen electrode 17, or separators 23. An oxygen barrier layer 33 surrounds and shields any part of the metal hydride anode 31 not in contact with one or more of the bipolar plates 35 and oxygen in the space of the vessel so as to prevent short-circuiting of the anode 31 by direct oxidation. The oxygen barrier layer 33 may be a stainless steel or conducting plastic cover or housing to protect the anode 31, but the contact of anode 31 and the cathode 17 must be electrically insulated, a sealing ring is needed in the inner side of the wall of the barrier 33. In a circulation-stacking model for galvanic cell units 3, electrical connections are simplified as compared to other models. The oxygen barrier 33 may be stainless steel or gas-tight conducting plastic cover or housing with an insulating sealing ring to electrically insulate anode 31 and cathode 17 in each cell unit.

The cathode may include a catalyst layer 21 and an oxygen or gas diffusion layer 19. The cathode 17 may be made of a catalyst having catalytic activity for oxygen reduction on its surface. A suitable catalyst may be a metal, metal oxide, or perovskite catalyst. Examples of metal catalysts may include silver catalyst or platinum catalyst. A metal oxide catalyst may be manganese oxide, for example. Catalysts used in the fuel cell embodiments described herein may be made from precursors that include AgNO₃, Co(NO₃)₂, a cobalt amine complex, Ni(NO₃)₂, Mn(NO₃)₂, platinum, palladium, ruthenium cyano complexes, organo metallic complexes, amino complexes, citrate/tartrate/lactate/oxalate complexes, transition metal complexes, transition metal macro-cyclics, and mixtures thereof. An example of a binder may be a halogenated olefin, such as polytetrafluoroethylene (PTFE). Other suitable binders may include one or more of polycarbonate, polypropylene, polyetherimide, polysulfonate, polyethersulfonate, polyarylether ketone, ethylene propylene diene monomer, ethylenepropylene rubber, or a derivative or halogenated derivative thereof.

The gas diffusion layer 19 may include carbon black and a binder, such as the binders disclosed above. The gas diffusion layer is disposed towards oxygen, which may include carbon black and a binder, such as PTFE. The cathode 17 may be an oxygen electrode. Suitable conducting materials may include carbon black and some adhesive, which may bind these materials together. In one embodiment, the cathode may have hydrophobic properties.

The gas diffusion layer 19 or inner wall of the pressure vessel 1 may also include oxygen storing materials. Examples of such materials are metal-organic frameworks (MOF) and ceria based ceramics. Metal-organic frameworks include metal oxide-based porous materials with a relatively large surface area allowing for a relatively increased ability to store gas. These materials allow for greater oxygen-storage ability in the closed space of the pressure vessel 1, such as in the oxygen channel 27. Oxygen is used as an oxidant for the oxygen electrode 17. It is consumed when the cell is discharged and is regenerated from water when the cell is recharged. The hydrogen produced is stored in the metal hydride anode 31. When the cell is overcharged, the excess hydrogen from the anode 31 will evolve through the membrane 23 and then combine with oxygen on the cathode side to produce water, therefore the internal pressure in the vessel may be effectively reduced.

The anode 31, or negative electrode, may be made of a substance that is readily oxidized or a substance that has catalytic activity for hydrogen. The term anode 31 applies to the electrode where oxidation takes place in which electrons are lost. The anode 31 may include a hydrogen storage-based material, such as a metal hydride. The metal hydride may be LaNi₅, for example. The anode 31 may be constructed using an active material, such as a metal hydride, a binder and conductive additives. The binder may be a gel mixture of PTFE and carboxymethylcellulose (CMC), for example. In one embodiment, the conductive additive may include nickel powder.

Suitable anode metal hydrides include but are not limited to nickel, Mm, Co, Al, Mn, Mo, Ti, Zn, Rh, Ru, Ir, La, Ni, Fe, Ti, Zr, W, V, B and alloys of these materials. The anode embodiments may include an active material supported on a current collector grid. The active material for the anode may include a hydrogen storage material, Raney Nickel, binder material, and graphite or graphitized carbon. The hydrogen storage material may be selected from Rare-earth metal alloys, Misch metal alloys, zirconium alloys, titanium alloys, magnesium/nickel alloys, and mixtures or alloys thereof which may be AB, AB2, or AB5 type alloys. Such alloys may include modifier elements to increase their hydrogen storage capability

The separator 23 may be a membrane. The membrane 23 is an electrically insulating material, but also has a high ion conductivity. Further, the membrane 23 is stable in alkaline environments. Examples of suitable membrane materials include non-woven polyethylene (PE), polypropylene (PP), composites of PE and PP, asbestos or nylon. The insulator plate 29 may be a perforated plastic plate, such as polyethylene, polypropylene or polyvinyl chloride.

The foregoing examples are merely illustrative of some of the features of the invention. The appended clauses are intended to define the invention as broadly as it has been conceived and the examples herein presented are illustrative of selected embodiments from a manifold of all possible embodiments. Accordingly it is Applicants' intention that the appended clauses are not to be limited in definition by the choice of examples utilized to illustrate features of the present invention. As used in the clauses, the word “comprises” and its grammatical variants logically also subtend and include phrases of varying and differing extent such as for example, but not limited thereto, “consisting essentially of” and “consisting of.” Where necessary, ranges have been supplied, those ranges are inclusive of all sub-ranges there between. It is to be expected that variations in these ranges will suggest themselves to a practitioner having ordinary skill in the art and, where not already dedicated to the public, those variations should be construed to be covered in the appended clauses. It is also anticipated that advances in science and technology will make equivalents and substitutions possible that are not now contemplated by reason of the imprecision of language and these variations should also be construed where possible to be covered by the appended clauses.

What is claimed is:

1. A galvanic cell structure, comprising:
a pressure vessel having components disposed in an interior volume, the components comprising;
a metal hydride anode,
one or more separators positioned on opposite sides of the metal hydride anode,
one or more oxygen electrodes positioned adjacent to each separator on sides opposite to the metal hydride anode,
insulator plates in contact with a respective oxygen electrode, and
an electrolyte in contact with one or more of the metal hydride anode, the oxygen electrode, insulator plate, or separator.

2. The galvanic cell structure of claim 1, wherein in the galvanic cell structure comprises a rechargeable fuel cell unit.

3. The galvanic cell structure of claim 1, wherein in the galvanic cell structure comprises a metal/air battery cell unit.

4. The galvanic cell structure of claim 1, wherein the pressure vessel encloses a plurality of sets of the components.

5. The galvanic cell structure of claim 1, wherein the electrolyte is an alkaline hydroxide.

6. The galvanic cell structure of claim 5, wherein the electrolyte comprises sodium hydroxide or potassium hydroxide.

7. The galvanic cell of claim 1, wherein the oxygen electrode comprises a catalyst layer and gas diffusion layer.

8. The galvanic cell of claim 7, wherein the catalyst layer comprises catalyst, a conductive particulate, and a binder.

9. The galvanic cell of claim 8, wherein the catalyst comprises one or more of a metal catalyst, metal oxide catalyst, or perovskite catalyst.

10. The galvanic cell of claim 8, wherein the catalyst comprises silver or manganese.

11. The galvanic cell of claim 8, wherein the conductive particulate is carbon-based.

12. The galvanic cell of claim 7, wherein the gas diffusion layer comprises carbon black and a binder.

13. The galvanic cell of claim 7, wherein the gas diffusion layer comprises an oxygen storage material.

14. The galvanic cell of claim 13, wherein the oxygen storage material comprises one or more metal-organic framework materials.

15. The galvanic cell of claim 13, wherein the oxygen storage material comprises one or more ceria-based ceramics.

16. The galvanic cell of claim 1, wherein the metal hydride anode comprises an active material, a binder, and at least one conductive additive.

17. The galvanic cell of claim 16, wherein the active material is a metal hydride.

18. The galvanic cell structure of claim 17, wherein the metal hydride is a LaNi₅ hydride.

19. The galvanic cell structure of claim 16, wherein the binder comprises one or both of polytetrafluoroethylene or carboxymethylcellulose.

20. The galvanic cell structure of claim 16, wherein the conductive additive comprises nickel powder.

21. The galvanic cell structure of claim 1, wherein the separator is configured as a membrane.

22. The galvanic cell structure of claim 1, wherein each of the insulator plates comprises plastic and defines a plurality of apertures.

23. The galvanic cell structure of claim 1, wherein the vessel is configured as a high-pressure container that is operable to contain a pressure of greater than 1 atmosphere.

24. The galvanic cell structure of claim 23, wherein the high-pressure container comprises steel or plastic.

25. A galvanic cell structure, comprising:
a pressure vessel having a set of components disposed in an interior volume, the components comprising:
a metal hydride anode having a surface;
one or more separators positioned on opposite sides of the metal hydride anode;
one or more oxygen electrodes positioned adjacent to each separator on an opposing side relative to the metal hydride anode;
an electrolyte in contact with one or more of the metal hydride anode, the one or more oxygen electrodes, or the one or more separators;
one or more bipolar plates having a surface with at least a portion of the bipolar plate surface in contact with at least a portion of a surface of the oxygen electrode and at least another portion in contact with at least a portion of the metal hydride anode surface; and
a barrier layer contacting and shielding another portion of the metal hydride anode surface that is not in contact with the one or more bipolar plates.

26. The galvanic cell structure of claim 25, wherein in the galvanic cell structure is a rechargeable fuel cell.

27. The galvanic cell structure of claim 25, wherein in the galvanic cell unit is a metal/air battery cell.

28. The galvanic cell structure of claim 25, wherein the pressure vessel encloses more than one set of the components.

29. The galvanic cell structure of claim 25, wherein the electrolyte comprises an alkaline hydroxide.

30. The galvanic cell structure of claim 29, wherein the electrolyte is sodium hydroxide or potassium hydroxide.

31. The galvanic cell of claim 25, wherein the oxygen electrode comprises a catalyst layer and gas diffusion layer.
